(19) United States
(12) Patent Application Publication
(10) Pub. No.: US 2008/0066186 A1
(43) Pub. Date: Mar. 13, 2008

(54) Method and Service Control Center for Updating Authorization Data in an Access Arrangement

(76) Inventor: Stefan Hammes, Regensburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/850,460

(22) Filed: Sep. 5, 2007

(30) Foreign Application Priority Data
Sep. 8, 2006 (DE) 10 2006 042 358.5

(51) Int. Cl. G06F 7/04

(52) U.S. Cl. 726/27

(57) ABSTRACT

At first, a communication connection is established between a communication terminal KE_B of an authorized user of the authorization data BD and a service control center SZ. A mobile communications connection is established between the service control center SZ and a communication device KE_SG_{—}1 of the access arrangement ZAO after successful identification of the user. If the service control center SZ has been successfully identified the authorization data BD is updated in the memory SP of the controller SG of the access arrangement ZAO. The authorization data BD in an access arrangement ZAO in a vehicle can thus be updated at any time without the assistance of a specialist workshop.

### CROSS-REFERENCE TO RELATED APPLICATIONS

This application claims priority to German Patent Application Number 10 2006 042 358.5 filed on Sep. 8, 2006, and which is incorporated herein by reference in its entirety.

### TECHNICAL FIELD

The present invention concerns a method for updating authorization data of an access arrangement and a service control center of an access arrangement for updating authorization data.

### BACKGROUND

To prevent unauthorized access to a vehicle, modern access authorization systems or access arrangements in vehicles use electronic security systems. With these systems data communication takes place between a first communication device of the vehicle and a second communication device, which is implemented in a user's mobile identification transmitter, to authenticate a user. This mobile identification transmitter can be, for example, a key or a key fob.

For this purpose request signals with a specific field strength are for example firstly emitted at regular intervals by the first communication device in order to check whether a mobile identification transmitter is situated in an approach region around the vehicle.

In other variants no regular request signals are sent, instead in these variants request signals are emitted for example on the basis of an event, for instance by pulling on the door handle—passive systems—or by pressing a button—remote control key system.

If in the first example a mobile identification transmitter approaches the vehicle and can finally receive the request signals thereof, it responds to receipt of the request signal with a data telegram with a characteristic identification code. The received identification code is then checked inside the vehicle. The validity or authorization of the approaching identification transmitter is established in the case of a positive or successful check.

Changes, updates or deletions of the authorization data of specific mobile identification transmitters stored in a memory of the access arrangement may only be carried out in specialist workshops.

From published patent application DE 10 2004 052 904 A1 a method for checking authorization of access to or use of a vehicle in particular is known. Signals are transmitted between at least one first transceiver and at least one further mobile transceiver. A distinction is made in this connection between a relatively large area and a significantly smaller distance. A distinction is made in this case with respect to a first request signal and a second request signal, a predefined action only being triggered if the second response signal is acknowledged.

From published patent application US 2005242923 A1 an access system is known in which a transceiver located in a vehicle automatically emits request signals continually or periodically to determine the presence of a transponder carried by the user as a function of a user input.

### SUMMARY

Updating of the authorization data of the access arrangement can be improved, according to an embodiment, by a method for updating authorization data of an access arrangement, the method comprising the steps of identifying a user unambiguously after a communication connection has been established between a communication terminal of an authorized user of the authorization data and a communication device of a service control center via a communication network, establishing a communication connection via a wireless communication network from a communication device of the service control center to a communication device of a controller of the access arrangement, unambiguously identifying the service control center by the controller of the access arrangement, and after transmitting an update request, updating the authorization data in the controller of the access arrangement.

According to another embodiment, a method for updating authorization data of an access arrangement, comprises the steps of identifying a user unambiguously after a communication connection has been established between a mobile communications terminal of an authorized user of the authorization data and a communication device of a controller via a mobile communication network, after an update request has been transmitted by the user, updating the authorization data in the controller of the access arrangement.

According to an enhancement, the user can be identified by voice recognition, by transmission of identification information or by a challenge-response method. According to a further enhancement, the identification information can be a personal identification number (PIN) or a transaction number (TAN). According to a further enhancement, the service control center can be identified by use of clear cryptographic information. According to a further enhancement, the communication connection via the wireless communication network can be established via a mobile communications network and/or a wireless local area network (WLAN) network. According to a further enhancement, communication between the communication device of the service control center and communication device of the access arrangement can be encrypted by using a common secret.

According to yet another embodiment, a service control center of an access arrangement for updating authorization data, may comprise a first communication module for establishing a communication connection with a communication terminal of an authorized user of the authorization data via a communication network, a first identification routine for an unambiguous identification of a user, a second communication module for establishing a communication connection via a wireless communication network with a communication device of a controller of the access arrangement, a second identification routine for clear identification of the service control center by the access arrangement, a third communication module for receiving update request information from the user, and an updating routine for updating authorization data in a memory of the service control center.

According to an enhancement, the wireless communication network can be a mobile communications network. According to a further enhancement, means can be provided for identifying the user by voice recognition, transmission of identification information or by a challenge-response method. According to a further enhancement, the identification information can be a personal identification number (PIN) or a transaction number (TAN). According to a further enhancement, means can be provided for identifying the user by using clear cryptographic information. According to a further enhancement, means can be provided for establishing a communication connection via the wireless communication network via a mobile communications network and/or wireless local area network (WLAN) network. According to a further enhancement, means can be provided for encrypting communication between the communication device of the service control center and the communication device of the access arrangement by using a common secret.

### BRIEF DESCRIPTION OF THE DRAWINGS

The method according to the invention will be described in more detail hereinafter with reference to drawings, in which:

FIG. 1 shows a schematic diagram of an arrangement for implementing the method according to an embodiment with a service control center,

FIG. 2 shows a schematic diagram of an arrangement of the method according to an embodiment in which updating is initiated by a mobile phone, and

FIG. 3 shows a schematic diagram of the service control center of an access arrangement.

### DETAILED DESCRIPTION

A fundamental aspect of the invention is that first of all a communication connection is established between an authorized user of the authorization data and a service control center. A mobile communications connection is established between the service control center and a communication device of the access arrangement after successful identification of the user. If the service control center has been successfully identified the authorization data is updated in the controller of the access arrangement.

A fundamental advantage of the method according to an embodiment lies in the fact that the authorization data can be updated at any time by a service control center without the assistance of a specialist workshop—for instance outside of its business hours or if it cannot be reached for some other reason. After initiation by the authorized user the entire process can also be fully automated by the service control center, i.e. take place quickly and without cost-inducing use of staff. Use of an existing mobile communications infrastructure and the possibility of implementing the service control center largely with the aid of commercially available server components can also reduce costs. Automation also minimizes the risk of invalid inputs. A further advantage according to an embodiment is the possibility of being able to carry out updating directly via a mobile phone without the aid of additional components.

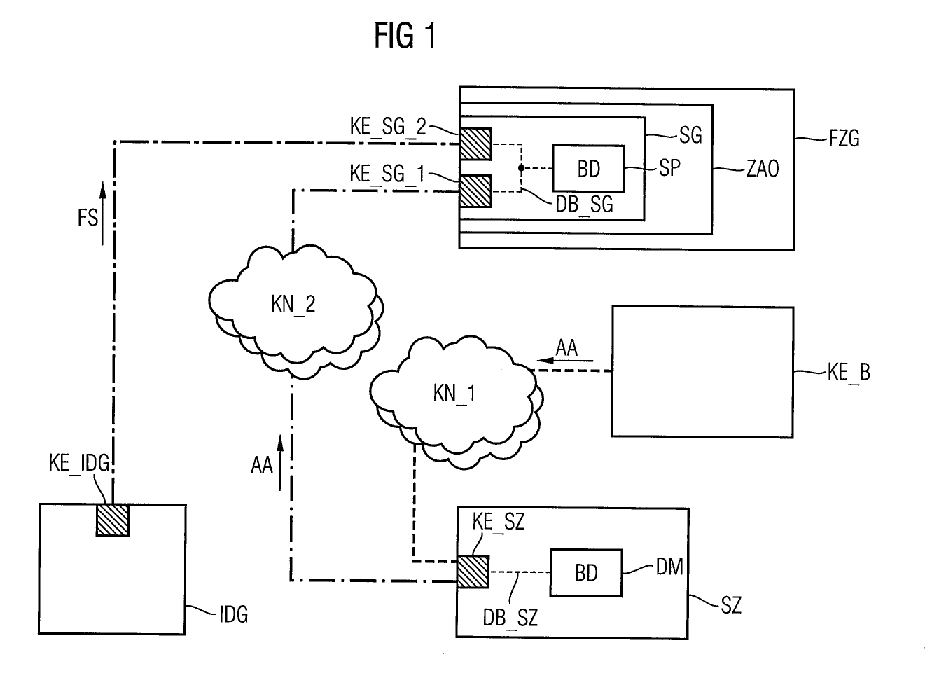

FIG. 1 schematically shows an arrangement for implementing the method according to an embodiment. It comprises a service control center SZ for updating authorization data BD of an access arrangement ZAO of a vehicle FZG and a user's communication terminal KE_B. The service control center SZ can be a server-based solution which comprises the conventional components and peripherals, such as processor, memory, network connection, operating system, application software, etc. (not shown). A first communication network KN_1 and a second mobile communications network KN_2 are also depicted. The user's communication terminal KE_B is for example a mobile terminal or a landline telephone terminal. The service control center SZ comprises a communication device KE_SZ via which the service control center SZ is connected to the communication network KN_1 and to the mobile communications network KN_2. The communication device KE_SZ is also connected in the service control center SZ to a data module DM by a data bus DB_SZ by using appropriate communication protocols. The authorization data BD was originally allocated by this data module DM or another competent device. The user's communication terminal KE_B is also connected, for example wirelessly, to the communication network KN_1.

The vehicle FZG has an access arrangement ZAO. This access arrangement ZAO has a controller SG. This controller SG is connected to the mobile communications network KN_2 by a communication device KE_SG_1. The authorization data BD of authorized users of the access arrangement ZAO is also stored in the controller SG in a memory SP.

A mobile identification transmitter IDG is also shown which has a communication device KE_IDG. By means of this mobile identification transmitter IDG it is possible, by means of its communication device KE_IDG, to transmit a coded and encrypted radio signal FS to a communication device KE_SG_2 of the controller SG of the access arrangement ZAO. Various functions of the access arrangement can be triggered using this radio signal FS. This can be, for example, the opening or closing of the door locking mechanism or the tailgate locking mechanism. Specific information has been associated with and stored in the mobile identification transmitter IDG and specific user data BD associated with and stored in the controller SG, for example by the data module DM of the service control center SZ. This information allows the access arrangement ZAO of a specific vehicle FZG to be operated only with a specific mobile identification transmitter IDG. The memory SP and the communication devices KE_SG_1 and KE_SG_2 are connected to each other by a data bus BD_SG by using appropriate communication protocols.

For the exemplary embodiment it is assumed that the mobile identification transmitter IDG is stolen from the authorized user by an unauthorized user. It is also conceivable that the mobile identification transmitter IDG has been lost by the authorized user. In both cases the authorized user of the mobile identification transmitter IDG has a great deal of interest in it not being possible for an unauthorized user to be able to gain access to the vehicle FZG via the mobile identification transmitter IDG and the access arrangement ZAO thereof. Finally it is also conceivable that the user, after he has updated the user data BD, finds the mobile identification transmitter IDG again and wants to be able to use it again.

For this purpose it has hitherto been necessary for the authorized user to find a specialist workshop which then usually updates the authorization data BD stored in the memory SP of the controller SG of the access arrangement ZAO. The result of this is that access to the vehicle FZG is no longer possible via the access arrangement ZAO using the lost or stolen mobile identification transmitter IDG.

However it is not always possible to reach a specialist workshop immediately after, for example, a theft or loss of a mobile identification transmitter IDG. This is very difficult for example at weekends or at night. Until such time as a specialist workshop can be found and the user data BD updated the vehicle FZG is exposed to a considerably increased risk of theft using the stolen or lost mobile identification transmitter IDG. The same applies moreover if the vehicle FZG including mobile identification transmitter IDG is stolen. There is considerable interest in updating the user data BD of the access arrangement as quickly as possible in these cases as well in order to prevent further misuse of the stolen vehicle FZG.

According to an embodiment it is possible that in such a case the authorized user of the authorization data BD can establish via the communication terminal KE_B and the communication network KN_1 a communication connection (shown in FIG. 1 by a dotted line) to a service control center SZ by means of the communication device KE_SZ thereof. The authorized user of the authorized data BD is unambiguously identified once this communication connection has been established according to the communication network KN_1 used and its communication network-specific protocols. This can take place for example by means of a voice recognition method. For this purpose it would be necessary for a voice sample to have been stored in advance for comparison of the voice of the caller and the authorized user. Clear identification of the authorized user is alternatively possible by transmitting encrypted identification information.

Known methods of user identification are the inputting of personal identification information—PIN—by the user, optionally together with transaction authentication information—TAN—that can be used once. These codes, which can include symbols in addition to numbers, are expediently produced by the service control center SZ and are passed to the user or transmitted in some other way when he first reports/registers to/with the service control center SZ.

Once the user has been unambiguously identified by the service control center SZ the user can give the service control center SZ an update request AA, either verbally or by means of suitable inputs. An update request AA of this kind could be, for example, “cancel key 2” or “cancel all keys”. In this situation the user can also make further requests of the vehicle FZG or functional devices, for example shutting down the complete vehicle by deactivating the motor control.

Once the authorized user of the authorization data BD has been unambiguously identified a communication connection (shown by a broken line in FIG. 1) is then produced from the communication device KE_SZ of the service control center SZ via the mobile communications network KN_2 to the communication device KE_SG_1 of the controller SG of the access arrangement ZAO.

The service control center SZ is accordingly unambiguously identified by the controller SG of the access arrangement ZAO. This can take place, for example, by using a clear cryptographic key. It is not necessary for this step to take place directly after identification of the user and establishing of the request update. To conserve power mobile phones in a car are only infrequently registered with the mobile communications network, for example every 30 minutes.

One possibility of identifying or authenticating the service control center SZ by the controller SG of the access arrangement ZAO is, for example, a challenge/response method. It is assumed in this connection that the controller SG of the access arrangement ZAO and the service control center SZ have a common cryptographic secret. This secret is expediently generated, either by the controller SG of the access arrangement ZAO or by the service control center SZ, when the user first reports/registers to/with the service control center SZ. The secret is then stored in the memory SP in the controller SG and a memory in the service control center SZ. Once communication between the service control center SZ and the controller SG has been established via the mobile communications network KN_2 the controller SG sends a request—challenge—to the service control center SZ from which the service control center SZ calculates the answer—response—using the cryptographic secret and sends it back to the controller SG of the access arrangement ZAO via the mobile communications network KN_2. This method has the advantage moreover that subsequent further communication between the service control center SZ and the controller SG via the mobile communications network KN_2 for transmitting the update request AA by using the common secret can also proceed encrypted and it therefore does not have to be assumed that the protocols running via the mobile communications network KN_2 provide sufficient data security per se.

A simpler method for identifying or authenticating the service control center SZ by the controller SG of the access arrangement ZAO is, like described above, use of a PIN code, optionally together with a TAN code that can be used once. These codes (i.e. PIN and optionally an adequate quantity of TAN codes) are expediently generated, either by the controller SG of the access arrangement ZAO or by the service control center SZ, when the user first reports/registers to/with the service control center SZ, and are stored in the memory SP of the controller SG and in the service control center SZ. Communication takes place unencrypted in this connection and it is assumed that the protocols running via the mobile communications network KN_2 provide sufficient data security.

In a variant of this method no identification data is stored by the service control center SZ itself, instead once communication has been established between service control center SZ and controller SG the service control center SZ transmits the user's identification data (as described above) to the controller SG. In this case the identification data (for example PIN code or TAN codes) are stored in the memory SP of the controller SG on the one hand and on other hand they are known to the user or stored for example in a memory in the user's communication terminal KE_B.

Once the service control center SZ has been unambiguously identified with respect to the controller SG the user's update request AA is transmitted from the communication device KE_SZ of the service control center via the mobile communications network KN_2 to the communication device KE_SG_1 of the controller SG. The authorization data BD is then updated in the memory SP of the controller SG of the access arrangement ZAO according to the update request AA. According to an embodiment this can consist in the corresponding authorization data BD of the mobile identification transmitter IDG, which has been stolen from or lost by the authorized user, being deleted.

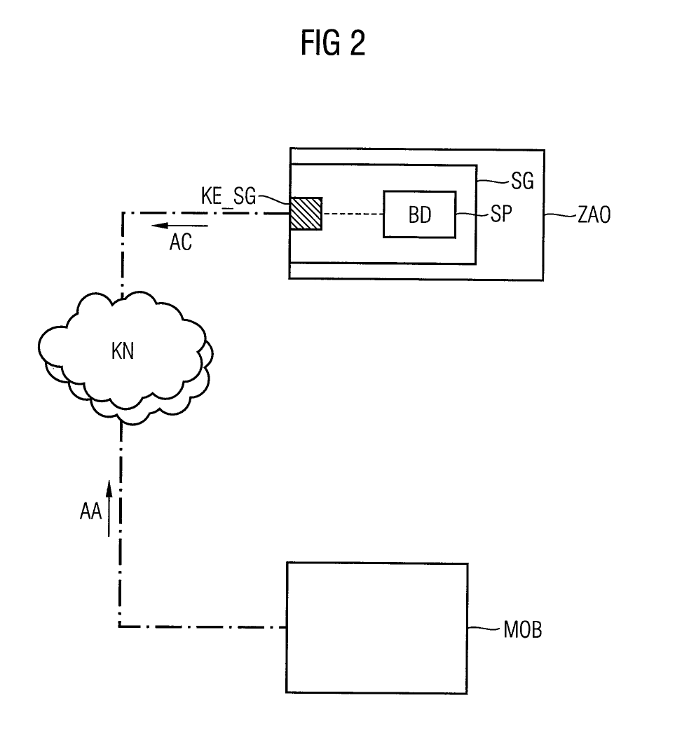

FIG. 2 shows a schematic diagram of an access arrangement ZAO of the method according to an embodiment in which updating of the authorization data BD is initiated by a mobile phone MOB. Also shown are a mobile communications network KN, the access arrangement ZAO, the controller SG, the memory SP and the communication device KE_SG of the controller.

According to an embodiment it is possible in this exemplary embodiment for the authorized user to also update the authorization data BD of the access arrangement ZAO without the aid of a service control center. For this purpose a connection is first of all established from the mobile terminal MOB of the authorized user via the mobile communications network KN to the communication device KE_SG of the access arrangement ZAO. There is then clear identification of the authorized user. This can take place in different ways. According to an embodiment the controller SG can generate an authorization code AC and send it, for example as a short message—SMS—via the communication device KE_SG to the authorized user's mobile terminal MOB. This can take place even before a potential theft or loss of the mobile identification transmitter IDG (not shown) or afterwards. This authorization code AC is stored in the mobile terminal MOB in a memory or on the SIM card thereof (not shown). In the case of a desired update of the user data BD, i.e. for example if the mobile identification transmitter IDG is lost or stolen, this authorization code AC has to be sent back to the communication device KE_SG. According to an embodiment a two-part identification can then take place. For this purpose a check is first of all made as to whether the authorization code AC has been sent by a known mobile communications terminal MOB or its SIM card. If this is the case the authorization code AC sent by the mobile communications device MOB is then checked in a second step by the controller SG of the access arrangement ZAO. If this check is positive, the authorization data BD in the controller SG is updated according to the request AA, for example is deleted.

This method for identifying the user can also be safeguarded further by the communication device of the controller KE_SG, after it has received the authorization code, sending a request, for example as a short message—SMS—, to an address (phone number) of a mobile communications terminal that has been previously stored in the controller SG or in the communication device of the controller KE_SG, which request then has to be acknowledged within a timeframe, for example again by a short message with an authorization code to the communication device of the controller KE_SG (not shown).

A further possible identification method is use of a challenge-response method described in detail above, a common secret being exchanged in advance between the controller SG of the access arrangement ZAO and the user's mobile communications terminal MOB or the SIM card thereof (not shown). In this connection the user's mobile communications device MOB has to authenticate itself with respect to the access arrangement ZAO.

Use of the above-described method is advantageous for reactivating user data BD in addition to deleting user data BD in the memory SP. This is useful for instance if an identification transmitter IDG that was initially thought lost is found again.

According to an embodiment the described method can be applied to RKE keys—remote keyless entry—or immobilization systems in addition to passive identification transmitters IDG.

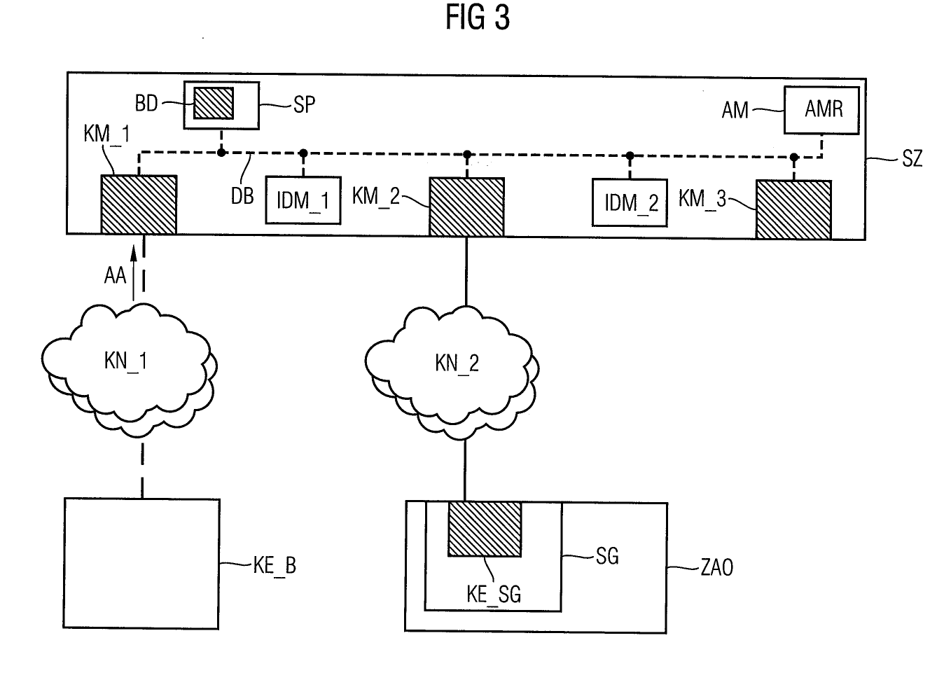

FIG. 3 schematically shows a service control center SZ of an access arrangement for updating authorization data BD. The service control center SZ comprises a memory SP and authorization data BD stored therein. The memory SP is connected via a data bus DB to a first identification module which allows a first identification routine IDM_1. A second identification module and an updating module AM are also connected to this data bus DB which allow a second identification routine IDM-2 and an updating routing AMR. Finally the service control center SZ comprises three communication modules KM_1, KM_2 and KM_3. A communication connection can be established from a user's communication terminal KE_B via a mobile communications network KN_1 by means of the first communication module KM_1. The second communication module KM_2 can establish a communication connection via a second communication network KN_2 to the controller SG of the access arrangement ZAO by means of the communication device KE_SG thereof.

It is also assumed for this exemplary embodiment that the mobile identification transmitter IDG has been stolen from the authorized user by an unauthorized user. Again it is possible according to an embodiment that, using his communication terminal KE_B, the authorized user of the authorization data BD establishes a communication connection via the communication network KN_1 to the service control center SZ by means of the communication device KE_Z thereof (shown in FIG. 3 by a long broken line). The communication network-specific protocols of the communication network KN_1 are used in this connection. By means of the first identification routine IDM_1 the authorized user is then identified by using one of the above-described identification methods. An update request AA is then transmitted by the user by means of his communication terminal KE_B to the service control center SZ. An update request AA of this kind could be for example “cancel key 1”. A mobile communications connection is thereafter established by means of the second communication module KM_2 via the mobile communications network KN_2 to the controller SG of the access arrangement ZAO via the communication device KE_SG thereof. This connection is shown as a solid line in FIG. 3.

The service control center SZ is now unambiguously identified by the controller SG. The second identification routine IDM_2 is used for this purpose. One of the above-described methods of identification can be used in this case.

Once identification has taken place the authorization data BD is updated in the controller SG and in the memory SP of the service control center SZ. The AMR updating routine is used for this purpose. Updating takes place according to the updating request AA of the authorized user.

Neither the method nor the arrangement are limited to the embodiments but can be used in all access arrangements, for example for buildings or electrical installations which have communication devices for communicating via communication networks. The communication devices should be coordinated with the communication networks and identification methods used in this connection.

What is claimed is:

1. A method for updating authorization data of an access arrangement, the method comprising the steps of:
identifying a user unambiguously after a communication connection has been established between a communication terminal of an authorized user of the authorization data and a communication device of a service control center via a communication network,
establishing a communication connection via a wireless communication network from a communication device of the service control center to a communication device of a controller of the access arrangement,
unambiguously identifying the service control center by the controller of the access arrangement, and
after transmitting an update request, updating the authorization data in the controller of the access arrangement.

2. The method according to claim 1, wherein the user is identified by voice recognition, by transmission of identification information or by a challenge-response method.

3. The method according to claim 2, wherein the identification information is a personal identification number (PIN) or a transaction number (TAN).

4. The method according to claim 1, wherein the service control center is identified by use of clear cryptographic information.

5. The method according to claim 1, wherein the communication connection via the wireless communication network is established via a mobile communications network and/or a wireless local area network (WLAN) network.

6. The method according to claim 1, wherein communication between the communication device of the service control center and communication device of the access arrangement is encrypted by using a common secret.

7. A method for updating authorization data of an access arrangement, comprising the steps of:
identifying a user unambiguously after a communication connection has been established between a mobile communications terminal of an authorized user of the authorization data and a communication device of a controller via a mobile communication network,
after an update request has been transmitted by the user, updating the authorization data in the controller of the access arrangement.

8. The method according to claim 7, wherein the user is identified by voice recognition, by transmission of identification information or by a challenge-response method.

9. The method according to claim 8, wherein the identification information is a personal identification number (PIN) or a transaction number (TAN).

10. The method according to claim 7, wherein the service control center is identified by use of clear cryptographic information.

11. The method according to claim 7, wherein the communication connection via the wireless communication network is established via a mobile communications network and/or a wireless local area network (WLAN) network.

12. The method according to claim 7, wherein communication between the communication device of the service control center and communication device of the access arrangement is encrypted by using a common secret.

13. A service control center of an access arrangement for updating authorization data, comprising:
a first communication module for establishing a communication connection with a communication terminal of an authorized user of the authorization data via a communication network,
a first identification routine for an unambiguous identification of a user,
a second communication module for establishing a communication connection via a wireless communication network with a communication device of a controller of the access arrangement,
a second identification routine for clear identification of the service control center by the access arrangement,
a third communication module for receiving update request information from the user, and
an updating routine for updating authorization data in a memory of the service control center.

14. The service control center according to claim 13, wherein the wireless communication network is a mobile communications network.

15. The service control center according to claim 13, wherein means are provided for identifying the user by voice recognition, transmission of identification information or by a challenge-response method.

16. The service control center according to claim 15, wherein the identification information is a personal identification number (PIN) or a transaction number (TAN).

17. The service control center according to claim 13, wherein means are provided for identifying the user by using clear cryptographic information.

18. The service control center according to claim 13, wherein means are provided for establishing a communication connection via the wireless communication network via a mobile communications network and/or wireless local area network (WLAN) network.

19. The service control center according to claim 13, wherein means are provided for encrypting communication between the communication device of the service control center and the communication device of the access arrangement by using a common secret.
